(19) United States
(12) Patent Application Publication
(10) Pub. No.: US 2008/0225235 A1
(43) Pub. Date: Sep. 18, 2008

(54) ROTATION MIRROR IMAGE DISPLAY

(76) Inventor: Tsun-I WANG, Taoyuan Hsien (TW)

Correspondence Address: SINORICA, LLC, 528 FALLSGROVE DRIVE, ROCKVILLE, MD, 20850, US

(21) Appl. No.: 11/759,970

(22) Filed: Jun. 8, 2007

(30) Foreign Application Priority Data
Mar. 14, 2007 (TW) 096108820

(51) Int. Cl. G02B 26/08; G03B 21/00

(52) U.S. Cl. 353/10; 359/226

(57) ABSTRACT

The present invention discloses a rotation mirror image display, which comprises: a driving means; a control unit for controlling at least one image and generating at least one image-control signal; a rotating member being continuously driven by the driving means and generating at least one mirror image; and at least one emitting module having a plurality of LEDs and disposed outside a rotating path of the rotating member; wherein the display with the mirror image is formed by way of rotating the rotating member and controlling the control unit to let the emitting module generate the mirror image.

### BACKGROUND OF THE INVENTION

1. Field of the Invention

The present invention generally relates to a display, more particularly to a display that uses the mirror theory to display a mirror image, that is, an emitting unit is mapped to a rotated mirror so as to display the mirror image.

2. Description of the Prior Art

LED to be a display or display has a lot of advantages, but with other considerations on the other side are of larger amount, higher cost, and higher power consumption. Therefore, a solution solves the disadvantages of LED display or display in prior arts. That is, to turn plural columns of LED modules becomes a cylindrical or spheral LED display.

The technologies for rapidly and periodically moving an LED matrix are as swing, rotation, etc. and disclosed in the ROC Patent No. 296828 and 563869. The U.S. Pat. No. 6,969,174 also discloses complicate driving mechanisms, a plurality of emitting members, and lots of operations to reach the final function.

Rotating or turning the LED module may need the conditions of power and signals sent to a rotating member and many other rotated electronic components. Hence, the whole structure for rotating or turning the LED module may be complicate and unstable, and with the negative factors for being manufactured, wherein:
1. too many control units causes higher accuracy;
2. complicate mechanisms are necessary to meet the higher accuracy of moving or rotation;
3. several sets of LED modules are used to enhance brightness or decrease flickness, so that the LED quality is important; and
4. aforesaid factors cause the difficulties to manufacturing due to the higher cost of mechanical and electronic components.

Additionally, U.S. Pat. No. 5,678,910 discloses a technology that uses a projector and a rotating apparatus to display images.

Therefore, how to figure out the disadvantages of prior arts is an important issue to the skilled people in the art.

### SUMMARY OF THE INVENTION

The primary objective of the present invention is to use one or several mirrors of a rotating member to generate one or several mirror images. By using the mirrors' rotating angle, which resolution is 2K, and one or N columns of LED modules (LEDMs) are controlled, wherein each column of LED module has M pieces of LEDs. Therefore there are K columns of mirror images generated by different rotating angles so as to form a 3-dimensional mirror image with the resolution of N*M*K or a 2-dimensional mirror image while N=1.

The secondary objective of the present invention is to generate a 2-dimensional cylindrical mirror image, a 2-dimensional spheral mirror image, or a 2-dimensional irregular mirror image, and plural 3-dimensional cylindrical mirror images or plural 3-dimensional spheral mirror images.

The third objective of the present invention is to use the structure to highly save manufacturing time and cost. That is, only one column of emitting module is enough to work with the rotating member in order to form mirror images. And the procedures for sorting, calibration, and accurate positioning LEDs can be neglected sometimes.

The present invention provides a reliable way to solve the disadvantages in prior arts. That is, not only the advantage of using one or several columns of emitting modules to generate 2-dimensional mirror images is existing, but also the disadvantage that the emitting module and other electronic components must be turned is eliminated. So that the structure is simple and more reliable.

By way of controlling one or plural rotated reflecting mirrors, setting a unit angle to acquire a rotating angle θₖ, and then controlling image-control signals from N columns of emitting modules firmly disposed around the one or plural rotated reflecting mirrors, then K columns of mapped images are shown on the circumference of the one or plural rotated reflecting mirrors so as to form a 2-dimensional or 3-dimensional rotating mirror image with the resolution of N*M*K, wherein N is equal to or larger than 1.

The rotating member is a rectangular mirror, the emitting module is shaped as a linear member, a cylindrical image is shown by the rotating member and the emitting module.

The rotating member is a disc mirror, the emitting module is shaped as an arc member and disposed around the rotating member, a spheral image is shown by the rotating member and the emitting module.

A 3-dimensional image are shown due to the plurality of emitting modules, which have different radii corresponding to a rotational center of the rotating member.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of a first preferred embodiment of the present invention;

FIG. 2 illustrates a schematic view of a relationship of a rotating angle and a mirror image of the present invention;

FIG. 3 illustrates a schematic view of position relationships of the mirror images produced by the plane mirror and the emitting module of the present invention;

FIG. 4 illustrates a schematic view of a second preferred embodiment of the present invention;

FIG. 5 illustrates a schematic view of a third preferred embodiment of the present invention;

FIG. 6 illustrates a schematic view of a fourth preferred embodiment of the present invention;

FIG. 7 illustrates a schematic view of a fifth preferred embodiment of the present invention;

FIG. 8 and FIG. 9 illustrate two schematic views of the imaging theory of the present invention;

FIG. 10 illustrates a schematic view of a dead space for observation in FIG. 7;

FIG. 11 illustrates a schematic view of a solution to solve the dead space for observation in FIG. 10;

FIG. 12 illustrates a schematic view of a sixth preferred embodiment of the present invention; and

FIG. 13 illustrates a schematic view of a mirror image for FIG. 12.

### DETAILED DESCRIPTION OF THE INVENTION

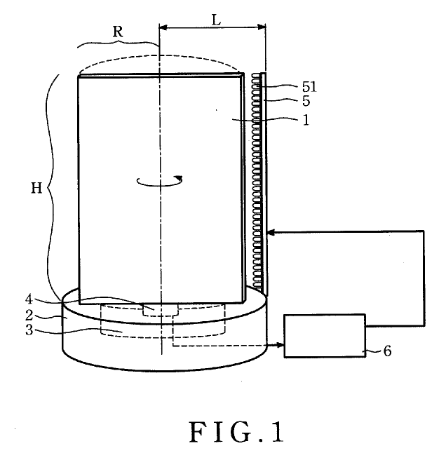

With reference to FIG. 1, which illustrates a schematic view of a first preferred embodiment of the present invention. Wherein a rotating member is a mirror 1 with a radius R and a height H. The mirror 1 having double reflecting surfaces is disposed on a platform 2 and driven by a driving device 3 as a motor in the platform 2. Further that, an angle encoder 4 is disposed in the driving device 3. The preferred embodiments disclosed by the present invention may adopt a plane mirror as the principle of the present invention but not limit to; others as convex mirror, concave mirror can be applied for different effects as well.

An emitting module 5 is firmly disposed on the circumference, the distance of L, of the platform 2 and around the rotating path of the plane mirror 1. The emitting module 5 is distributed a plurality of LEDs 51, which quantity is defined as M and can be monochromatic or polychromic. The emitting module 5 receives the image-control signal of a control unit 6 for controlling images in order to emit light. The image-control signal from the control unit 6 is processed by an input video signal and a signal from the angle encoder 4. If the angular resolution is 2K, the control unit 6 obtains a present angle value of the plane mirror 1 from the signal of the angle decoder 4 so as to acquire the mapped mirror image signal of a current mirror position, and send the signal to the emitting module 5 for producing the image in the plane mirror 1. Continuously to output the image signal of the mirroring position to the emitting module 5 can output the image via the input video signal.

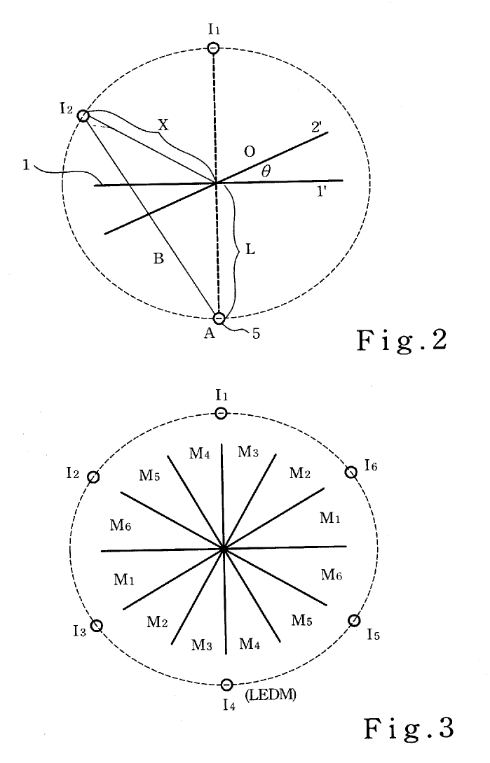

With reference to FIG. 2, which illustrates a schematic view of a relationship of the rotating angle and the mirror image of the present invention. As shown in FIG. 2, while the plane mirror 1 is at a position 1′, a mirror image of the emitting module 5 is I1, and the mirror image angle θi (1) is 90°; while the plane mirror 1 moving to a position 2′ with a moving angle θ, another mirror image of the emitting module 5 is 12. By the mirror theory, ΔAOB=ΔI2OB, so that:

X=L (1-1), and

θi(2)=90°+2θ (1-2),

According to equation (1-1), the mirror images of the mirror positions I1 and I2 are at the same circumference according to the radius L, and the rotating angle of the mirror images is defined as θi(2)−θi(1)=2θ. Then, the position of the mirror image of the emitting module is defined by that of 2 multiplied by the angle θ from the angle decoder. Assuming that the resolution of the angle decoder is 2K, then the resolution of the mirror image is K. Hence, a 2-dimensional mirror image with the resolution of K*M can be shown on the circumference, which is defined by the center O, the radius L, and the height H.

According to equation (1-2), while the plane mirror is rotated 180°, the mirror image is rotated an angle, which is 360° defined by 2 θ. It is then that a 360° mirror image is twice appeared while the plane mirror is rotated a circle. As an example, the plane mirror is rotated 15 circles per second, a 360° image is appeared for 30 times per second. This frequency is within the scope of persistence of view of human beings, and therefore a static 2-dimensional mirror image can be seen.

With reference to FIG. 3, which illustrates a schematic view of position relationships of the mirror images produced by the plane mirror and the emitting module of the present invention. As shown in FIG. 3, the plane mirror 1 is rotated to six positions, which are M1, M2, M3, M4, M5, and M6 in sequence, and the positions of the mirror images are I1, I2, I3, I4, I5, and I6 in sequence. Therefore, while the plane mirror 1 is rotated 180°, the mirror image is then rotated 360° accordingly. As aforesaid equation (1-2), if the plane mirror is turned the angle θ, the mirror image is then turned the angle 2θ. If the rotating angle is between 180° to 360°, the mirror image is restarted from another 360° image due to the plane mirror 1 with two reflecting surfaces. Hence, if the resolution of the angle decoder is 2K in a circle, such as the angle of 360°, that is, only the resolution K is mapped while at the angle of 180°; but the mirror position of 180° is mapped to the mirror image of 360°, so that the resolution of a generated image is only K.

The control unit 6 in FIG. 1 transforms the input image signals to the image with the resolution of K*M. Wherein the resolution M is mapped to the M positions of plural LEDs 51 in the emitting module 5. The control unit 6 uses the M image-control signals of the mapped Kth column to control that the emitting module 5 emits light with corresponding brightness via a θk input by the angle decoder 4. Continuously, the resolution and height of the column of a mirror image are M and H. So that a 2-dimensional image with a radius L and the height H is displayed. The refresh rate, as image refresh rate per second, of the image is 2f, wherein f is the rotating speed of the plane mirror. And the rotating angle of the plane mirror can be acquired by the angle encoder 4.

The angle encoder can be replaced by another way, which uses a switch as a light sensor or magnetic sensor, ex. Hall-sensor, to be a start point, then a time Tc for turning a circle is divided into 2K divisions averagely, therefore each division ΔT is equal to Tc/2K, and ΔT is corresponding to a time gap between each two columns of the emitting modules. The circumference of the mirror image is mapped an image with K columns, and the mapped image starts from the start point, defined as the angle of zero, an angle between each pair of columns is 360°/K.

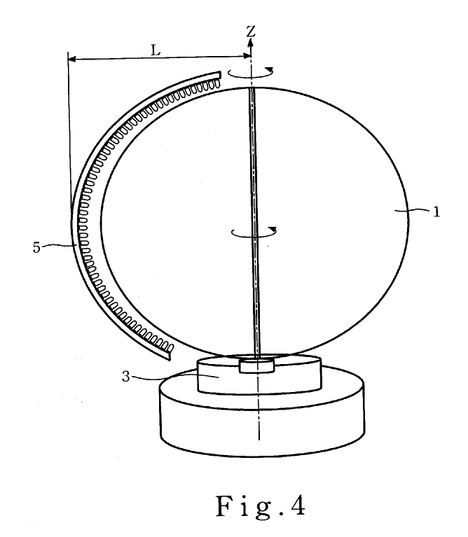

With reference to FIG. 4, which illustrates a schematic view of a second preferred embodiment of the present invention. As shown in FIG. 4, the plane mirror 1 is a disc mirror and turned around a z-axis by the driving device 3, such as a motor. The emitting module 5 is around the disc mirror 1 as well and shaped as an arc member. By way of the theory applied to the first preferred embodiment, the mirror image of the emitting module 5 is a spheral image with a radius L. The embodiment can construct a spheral display.

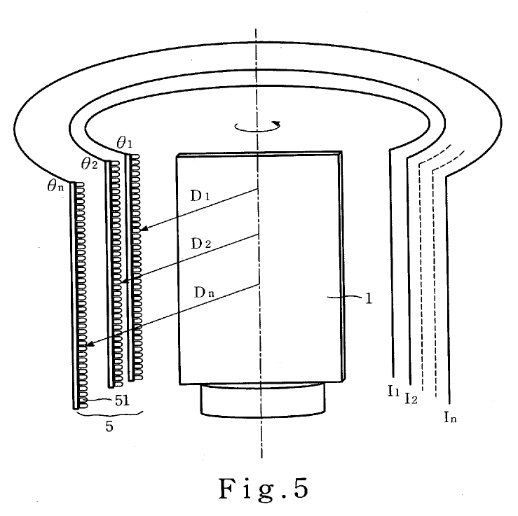

With reference to FIG. 5, which illustrates a schematic view of a third preferred embodiment of the present invention. Wherein there are N columns of emitting modules 5 disposed around the plane mirror 1 at different locations, where are defined by different angles θ. The emitting modules are named as LEDM₁, LEDM₂, . . . , and LEDM_{N}. Each column of emitting module 5 has M pieces of LEDs 51, which can be monochromatic or polychromic and mounted on different positions with different distances, such as several radii. If the resolution of rotating the plane mirror 1 a circle is 2K, and then the mirror images of the N columns of emitting modules 5 are displayed as N cylindrical images I₁, I₂, . . . , and Iₙ with different radii, such as D₁, D₂, . . . , and Dₙ. Each cylindrical image is a 2-dimensional image with the resolution M*K. Therefore, the N cylindrical images forms I₁, I₂, . . . , and Iₙ a 3-dimensional mirror image with resolution N*M*K, which can be visible to the eyes.

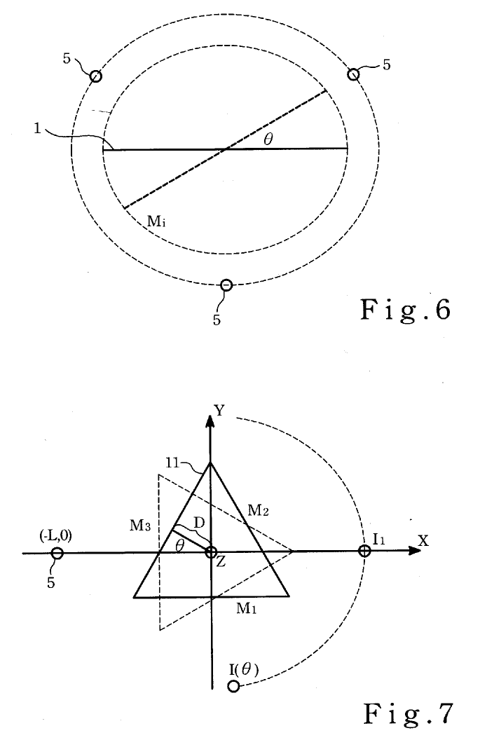

With reference to FIG. 6, which illustrates a schematic view of a fourth preferred embodiment of the present invention. Plural columns of the emitting modules LEDM₁, LEDM₂, . . . , and LEDM_{N} are averagely disposed around the plane mirror 1 and with the same radius in order to generate the mirror images through that the control unit controls each column of emitting module, and the mirror images are the same as each other. So that the image refresh rate per second can be increased and the image brightness is enhanced as well. The image refresh rate is 2fN, and the image brightness is then N times. As an example in FIG. 6, the three columns of emitting modules 5 are averagely disposed around the plane mirror 1, the rotating speed f of the plane mirror 1 is equal to 10 circles/sec., and therefore the image refresh rate R is 60 time/sec., that is, R=2*10*3. Detail description is as below:

while turning the plane mirror 1 to the position angle θ(t), the relationships for the positions of the mirror images of the three columns of emitting modules 5 are as the three equations listed below:

θᵢ₁(t)=90°+2θ(t) (5-1),

θᵢ₂(t)=210°+2θ(t) (5-2), and

θᵢ₃(t)=330°+2θ(t) (5-3),

hence, for any mirror image angle θᵢ, three mirror position angles θ₍ₜ₁₎, θ₍ₜ₂₎, and θ₍ₜ₃₎ can be determined by equations (5-1), (5-2), and (5-3) as below:

θ₍ₜ₁₎=(θi−90°)/2,

θ₍ₜ₂₎=(θi−210°)/2, and

θ₍ₜ₃₎=(θi−330°)/2,

since the plane mirror 1 is turned 180°, there are three mirror images generated. As a result, the refresh rate of the mirror image is 6f time/sec.

With reference to FIG. 7, which illustrates a schematic view of a fifth preferred embodiment of the present invention. The embodiment adopts a polyhedral member to reflect, and it is assembled by N pieces of mirrors so as to become a polyhedral mirror set. If the polyhedral mirror set is turned around the central axis and the rotating speed is f circle/sec., the refresh rate of the mirror image will be as R=Nf time/sec. As an example in FIG. 7, the polyhedral mirror set 11 is shaped as a prism and assembled by three plane mirrors M1, M2, and M3. The point Z is an origin for the coordinate x-y, and there is a column of emitting module 5 disposed at the coordinate (−L, 0). While the polyhedral mirror set 11 is at a first position and appeared by dotted lines, the mirror image of the column of emitting module 5 in the plane mirror M3 is I1; while the polyhedral mirror set 11 is at a second position and appeared by active lines, that is, the plane mirror M3 is turned an angle θ, and the coordinate of the mirror image of the plane mirror M3 can be determined by following equations:

Xi(θ)=L cos 2θ−2D cos θ (7-1),

Yi(θ)=−L sin 2θ+2D sin θ (7-2)

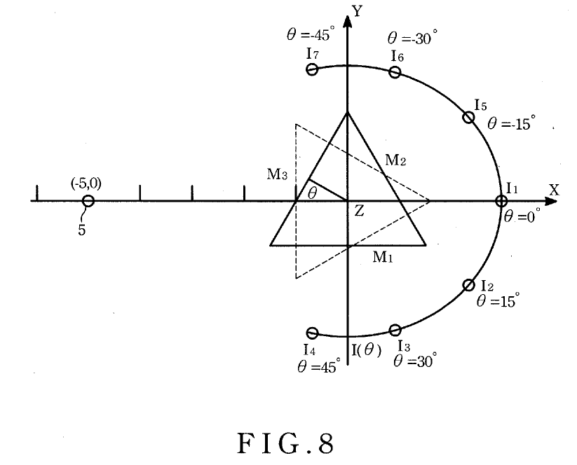

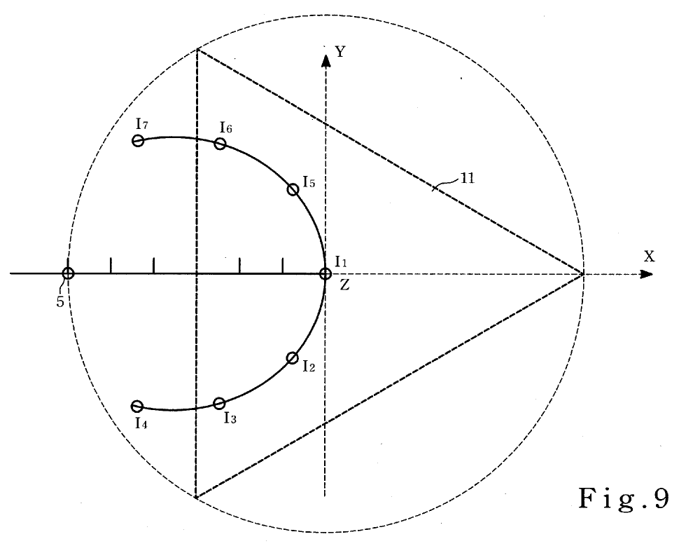

therefore the moving path of the mirror image is plotted and shown as an arc dotted line in FIG. 7. With reference to FIG. 8 and FIG. 9, which illustrate two schematic views of the imaging theory of the present invention. In FIG. 8, while under the condition of L=5D, the moving path of the mirror image of the column of emitting module 5 in the plane mirror M3 is from I1 to I7. As shown in FIG. 9, while the column of emitting module 5 is just located at the turning path, as a circumference, of the polyhedral mirror set 11, that is, the condition of L=2D, the moving path of the mirror image is from I1 to I7, and the width of the mirror image is about 1.4D and smaller than the width of the polyhedral mirror set 11. Further that, the width of the polyhedral mirror set 11 is 2\sqrt{3} D.

According to equations (7-1) and (7-2), the moving path of the mirror image is not a roundness curve; on the other hand, while L>>D, equations (7-1) and (7-2) derive the equation of Xi²+Yi²=L² so as to make the moving path of the mirror image approach a roundness curve. The angle θi of the mirror image of the column of emitting module 5 can be determined from equations (7-1) and (7-2), and the angle θi is then equal to |tan⁻¹(yi/xi)|, but not equal to 2θ. So that this is not a linear relationship with the angle θ of the mirror position. By way of numeric operations, the non-linear relationship can be stored in a memory in order to let the control unit output the mapped image signal of the mirror image to produce a 2-dimensional image.

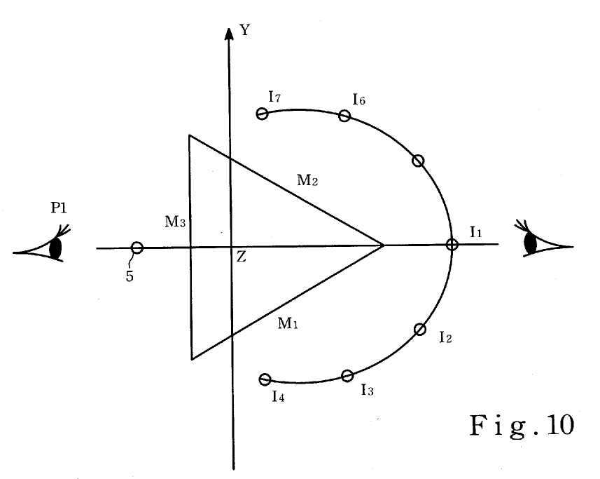

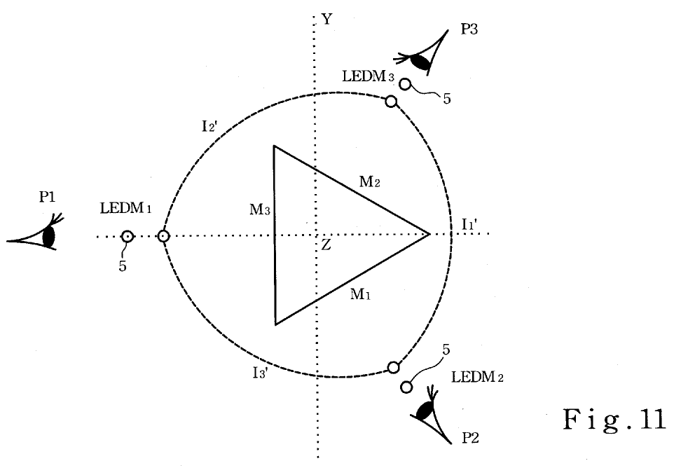

Please refer to FIG. 10, which illustrates a schematic view of a dead space for observation in FIG. 7. As shown in FIG. 10, there is an observer P1, who can watch the mirror image of the column of emitting module 5; but another observer P2 right in front of the column of emitting module 5 cannot watch the mirror image. To compensate the problem, more columns of emitting modules 5 can be disposed around the polyhedral mirror set 11 for different directions of observers. In FIG. 11, which illustrates a schematic view of a solution to solve the dead space for observation in FIG. 10, and there are three columns of emitting modules LEDM₁, LEDM₂, and LEDM₃ averagely disposed. The moving path I₁′ of the mirror image of the emitting module LEDM₁ can be watched by the observer P1; the moving path I₂′ of the mirror image of the emitting module LEDM₂ can be watched by the observer P2; and the moving path I₃′ of the mirror image of the emitting module LEDM₃ can be watched by the observer P3. As a result, a full-range image is displayed.

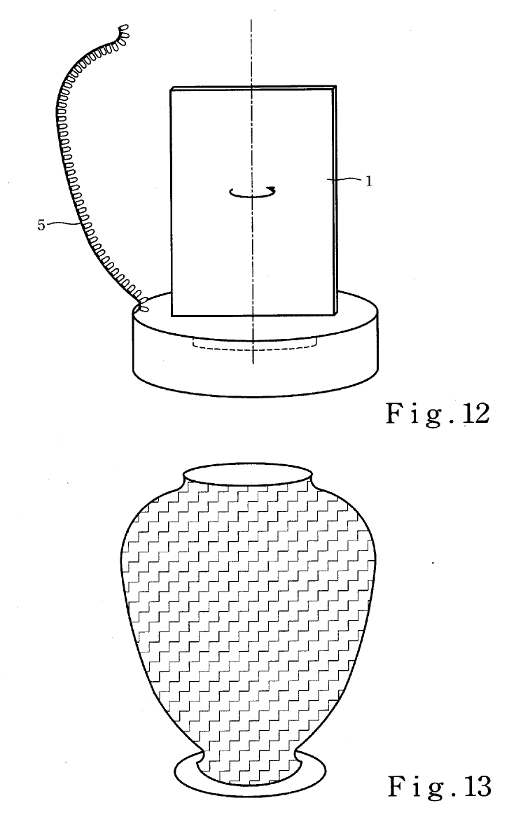

Referring to FIG. 12, which illustrates a schematic view of a sixth preferred embodiment of the present invention. That is another application to an irregular member. The column of emitting module 5 is irregularly shaped so as to form a special 3-dimensional image while turning the plane mirror 1. Referring to FIG. 13, which illustrates a schematic view of a mirror image for FIG. 12. The mirror image is like a vase, since the shape of the column of emitting module 5 is designed as a half figure of a symmetric vase. As a conclusion, the shape of the emitting module 5 can be designed for any figure to meet any 3-dimensional image.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A rotation mirror image display, comprising:
a driving means;
a control unit for controlling at least one image and generating at least one image-control signal;
a rotating member being continuously driven by the driving means and generating at least one mirror image; and
at least one emitting module having a plurality of LEDs and disposed outside a rotating path of the rotating member;
wherein the display with the mirror image is formed by way of rotating the rotating member and controlling the control unit to let the emitting module generate the mirror image.

2. The rotation mirror image display according to claim 1, wherein the rotating member is a rectangular mirror, the emitting module is shaped as a linear member, a cylindrical image is shown by the rotating member and the emitting module.

3. The rotation mirror image display according to claim 1, wherein the rotating member is a disc mirror, the emitting module is shaped as an arc member and disposed around the rotating member, a spheral image is shown by the rotating member and the emitting module.

4. The rotation mirror image display according to claim 1, wherein a 3-dimensional image are shown due to the plurality of emitting modules, which have different radii corresponding to a rotational center of the rotating member.

5. The rotation mirror image display according to claim 1, wherein the rotating member is a polyhedral member assembled by at least three mirrors, and therefore an refresh rate of the image is increased.

6. The rotation mirror image display according to claim 1, wherein the plurality of emitting modules are disposed as a plurality of columns with average angles and outside of the rotating path of the rotating member, the control unit controls each emitting module to have the same mirror image at the same position, therefore the combination of each mirror image produces a higher refresh rate and brighter image.

7. The rotation mirror image display according to claim 1, wherein the emitting module is shaped as a specified irregular shape, therefore a specified 3-dimensional image is shown by way of rotating the rotating member.

8. The rotation mirror image display according to claim 1 further comprising an angle encoder, which acquires a rotating angle of the rotating member in order to control each position of the mirror image from the emitting module.

9. The rotation mirror image display according to claim 6 further comprising a switch, which is a sensor to get one circle time Tc of the rotating member, Tc is divided into 2K divisions averagely, therefore each division ΔT is equal to Tc/2K, and ΔT is corresponding to a time gap between each two columns of mirror images of the emitting modules.

10. The rotation mirror image display according to claim 1, wherein the emitting module emits light by way of receiving the image-control signal from the control unit.

11. A rotation mirror image display comprising:
a mirror, which is driven by a driving means for rotation; and
at least one column of emitting module around the mirror;
wherein the display showing a 2-dimensional or 3-dimensional mirror image is then formed by rotationally moving the mirror to control at least one image-control signal of the column of emitting module.

12. The rotation mirror image display according to claim 11, wherein the image-control signal comprises an input signal of a control unit for controlling at least one image and a signal from an angle encoder.

13. The rotation mirror image display according to claim 11, wherein the mirror is a reflector, which has double reflecting surfaces.

14. A rotation mirror image display comprising:
a motor;
a control unit for controlling at least one image generating at least one image-control signal;
a mirror being continuously rotated by the motor; and
at least one emitting module having a plurality of LEDs and disposed outside a rotating path of the mirror;
wherein the display with a mirror image is formed by way of rotating the mirror and controlling the control unit to let the emitting module generate the mirror image.

15. The rotation mirror image display according to claim 14, wherein the mirror is a rectangular mirror, the emitting module is shaped as a linear member, a cylindrical image is shown by the mirror and the emitting module.

16. The rotation mirror image display according to claim 14, wherein the mirror is a disc mirror, the emitting module is shaped as an arc member and disposed around the mirror, a spheral image is shown by the mirror and the emitting module.

17. The rotation mirror image display according to claim 14, wherein a plurality of 3-dimensional image are shown due to the plurality of emitting modules, which have different radii corresponding to a rotational center of the mirror.

18. The rotation mirror image display according to claim 14, wherein the mirror is a polyhedral mirror assembled by at least three mirrors, and therefore an refresh rate of the image is increased.

19. The rotation mirror image display according to claim 14, wherein the plurality of emitting modules are disposed as a plurality of columns with average angles and outside of the rotating path of the mirror, the control unit controls each emitting module to have the same mirror image at the same position, therefore the combination of each mirror image produces a higher refresh rate and brighter image.

20. The rotation mirror image display according to claim 14, wherein the emitting module is shaped as a specified irregular shape, therefore a specified 3-dimensional image is shown by way of rotating the mirror.

21. The rotation mirror image display according to claim 14 further comprising an angle encoder, which acquires a rotating angle of the mirror in order to control each position of the mirror image from the emitting module.

22. The rotation mirror image display according to claim 19 further comprising a switch, which is a sensor to get one circle time Tc of the mirror, Tc is divided into 2K divisions averagely, therefore each division ΔT is equal to Tc/2K, and ΔT is corresponding to a time gap between each two columns of mirror images of the emitting modules.

23. The rotation mirror image display according to claim 14, wherein the emitting module emits light by way of receiving the image-control signal from the control unit.
